(19) United States
(12) Patent Application Publication
(10) Pub. No.: US 2018/0350326 A1
(43) Pub. Date: Dec. 6, 2018

(54) BIT-PACKING FOR ADVANCED COLOR IMAGES

(71) Applicant: Microsoft Technology Licensing, LLC, Redmond, WA (US)

(72) Inventors: Sandeep KANUMURI, Redmond, WA (US); Sudhanshu SOHONI, Redmond, WA (US)

(21) Appl. No.: 15/728,019

(22) Filed: Oct. 9, 2017

Related U.S. Application Data
(60) Provisional application No. 62/513,064, filed on May 31, 2017.

(51) Int. Cl. G09G 5/393

(52) U.S. Cl. CPC G09G 5/393; H04N 5/23229; G09G 2340/02

(57) ABSTRACT

Described are examples for storing an advanced color image. A set of values stored in a first number of byte values can be determined, where each value in the set of values corresponds to a parameter of a set of parameters representing one or more pixels of an advanced color image. The set of values can be packed into a set of byte values, where a second number of byte values in the set of byte values is less than the first number of byte values. The set of byte values can be stored or communicated in representing the one or more pixels of the advanced color image.

### CLAIM OF PRIORITY UNDER 35 U.S.C. § 119

The present Application for Patent claims priority to Provisional Application No. 62/513,064, entitled “BIT-PACKING FOR ADVANCED COLOR IMAGES” filed May 31, 2017, which is assigned to the assignee hereof and hereby expressly incorporated by reference herein for all purposes.

### BACKGROUND

Many computing devices are equipped with cameras for digitally capturing images, video, etc. for storing on the computing device or other repositories for subsequent viewing. Cameras are typically capable of capturing high quality raw images, but often down-convert the raw images to 8-bit red, green, blue (RGB) (e.g., in the form of a joint photographic experts group (JPEG)) for processing by a computing device, and/or display on an associated display compatible for displaying 8-bit JPEGs. As camera processing capabilities increase, so do technologies for photo capture and display. Additional standards have been proposed for displaying advanced color images, such as high definition images including ultra high definition (UHD), wide color gamut (WCG), high dynamic range 10-bit (HDR10), and high dynamic range 12-bit (HDR12), which can be capable of producing 10-bit to 14-bit images.

Also, different storage formats have been proposed for such images, which can represent a pixel in one or more luminance (Y) and/or chroma (Cb, Cr) values. It has been observed that chroma channels can have a lower sampling rate than the luminance channel without dramatic loss of perceptual quality, and thus storage formats for the advanced color images often have a full sampling of luminance (e.g., four luminance values) and partial sampling of chroma (e.g., one Cb and one Cr value) per pixel. Some proposed formats can be planar, such as P010 format for 10-bit advanced color images, where the multiple luminance values are represented in adjacent memory locations in one portion of memory while the corresponding chroma values are represented in adjacent memory locations in another portion of memory. Some proposed formats can be packed, such as Y210 format for 10-bit advanced color images, where luminance values and chroma values are represented together in adjacent memory locations (e.g., alternating as a first luminance value, a corresponding Cb value, a second luminance value, a corresponding Cr value, etc. for the pixel).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a method for storing an advanced color image is provided. The method includes determining a set of values stored in a first number of byte values, where each value in the set of values corresponds to a parameter of a set of parameters representing one or more pixels of an advanced color image, packing the set of values into a set of byte values, where a second number of byte values in the set of byte values is less than the first number of byte values, and storing the set of byte values to represent the one or more pixels of the advanced color image.

In another example, a device for storing an advanced color image is provided, that includes an image sensor configured to capture a raw image, a memory for storing one or more parameters or instructions for storing the raw image as an advanced color images in a set of byte values, and at least one processor coupled to the memory. The at least one processor is configured to determine a set of values stored in a first number of byte values, where each value in the set of values corresponds to a parameter of a set of parameters representing one or more pixels of an advanced color image, pack the set of values into the set of byte values, where a second number of byte values in the set of byte values is less than the first number of byte values, and store the set of byte values to represent the one or more pixels of the advanced color image.

In another example, a computer-readable medium, including code executable by one or more processors for storing an advanced color image, is provided. The code includes code for determining a set of values stored in a first number of byte values, where each value in the set of values corresponds to a parameter of a set of parameters representing one or more pixels of an advanced color image, packing the set of values into a set of byte values, where a second number of byte values in the set of byte values is less than the first number of byte values, and storing the set of byte values to represent the one or more pixels of the advanced color image.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for storing and/or communicating advanced color images using bit packing.

FIG. 2 is a flow diagram of an example of a method for storing and/or communicating advanced color images using bit packing.

FIG. 3 is a diagram of examples of byte lines including packed bits representing an advanced color image.

FIG. 4 is a schematic diagram of an example of a device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to performing bit-packing of values corresponding to pixels for representing advanced color images, such as high definition images including ultra high definition (UHD), wide color gamut (WCG), high dynamic range 10-bit (HDR10), high dynamic range 12-bit (HDR12), etc. For example, values for luminance (Y) and chroma (Cb, Cr) of one or more pixels can be initially stored or otherwise represented in values having multiple bytes, such as a 16-bit value (e.g., two bytes). In representing 10-bit values (e.g., for a 10-bit advanced color image), the values for the one or more pixels may be stored in two bytes (16 bits) in memory where the six least significant bits of each value are set to 0. Thus, for an advanced color image stored in a format having four luminance values and corresponding Cb and Cr chroma values, such as in P010, Y210, etc., six 2-byte (e.g., 16-bit) values (e.g., for a total of 96 bits) can be utilized for storing corresponding pixels. In this regard, memory may be unnecessarily used in storing the various values to represent the pixels (e.g., at least 36 of the 96 bits may be wasted as six bits in each 16-bit value are set to zero in representing a 10-bit value).

Accordingly, for example, the values representing a given pixel or a number of pixels can be bit-packed into a lesser number of total byte values (and thus may utilize a lesser number of total bits/bytes for representing the advanced color image). In addition, for example, the bit-packed values may include alternating values for luminance and chroma to decrease buffering requirements when a device receiving the bit-packed advanced color image reads out the values for rendering the advanced color image. In a specific example, bit-packing can include storing the luminance values as one or more modified values that use a less number of bits in an attempt to achieve a less number of total byte values. In addition, in this example, the chroma values can be stored using a less number of bits to achieve the less number of total byte values. In another example, bit-packing can include storing luminance values together in multiple byte values, providing a multiple byte value for each of multiple pixels in even and odd bit-lines, and storing multiple chroma values corresponding to the multiple pixels together in a multiple byte value. In either case, the bits can be packed to achieve complete usage of byte values in storing the advanced color image.

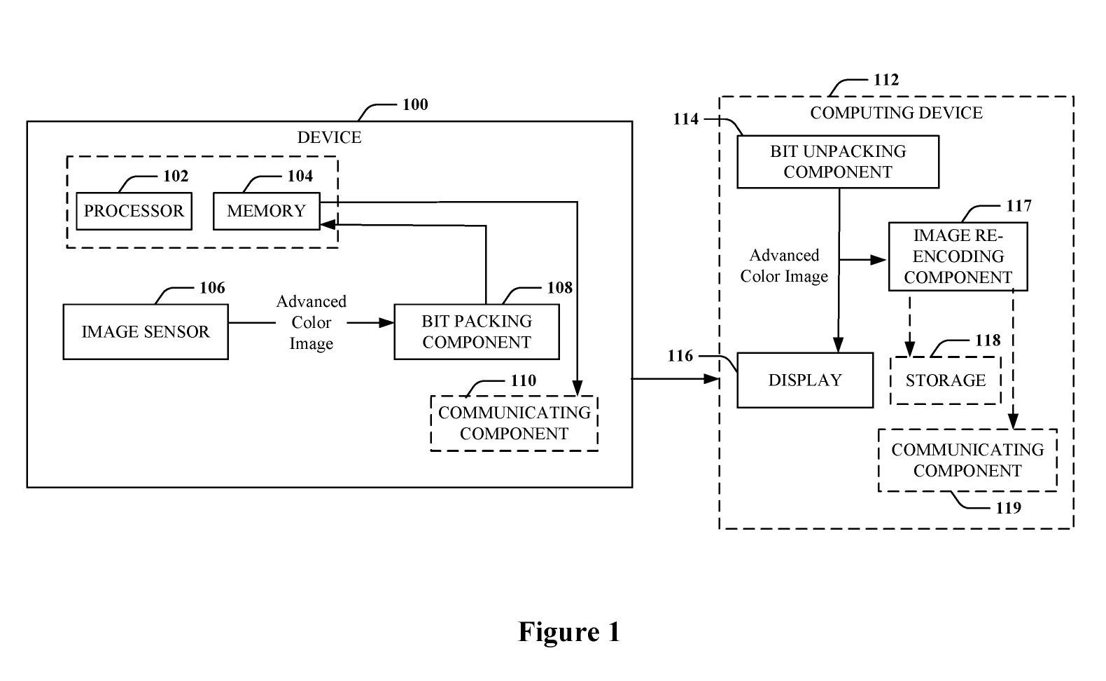

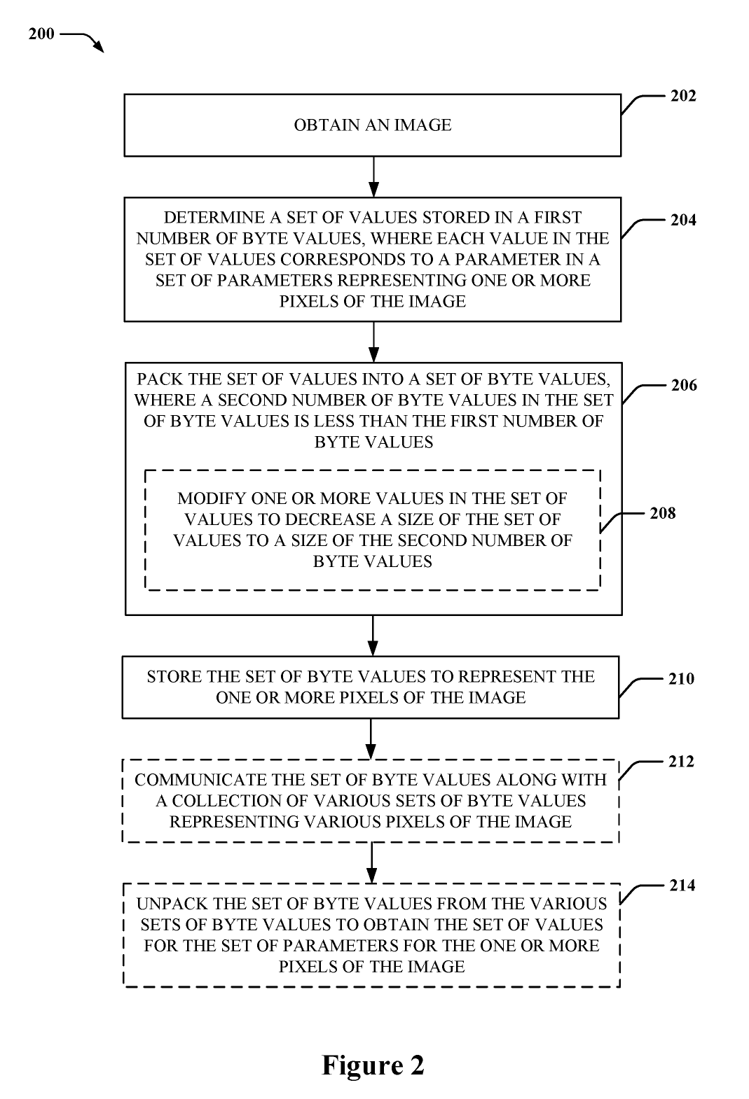

Turning now to FIGS. 1-4, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a device 100 that can capture advanced color images, and can pack bits for more efficient storing and/or communicating of pixels of the advanced color images. In an example, device 100 can include a processor 102 and/or memory 104 configured to execute or store instructions or other parameters related to operating or providing one or more of an image sensor 106, a bit packing component 108, a communicating component 110, etc., as described further herein. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein. Device 100 can communicate with a computing device 112 (e.g., via communicating component 110), which can also include a processor and memory, though not shown. In one example, device 100 and computing device 112 may be similar devices having similar components. In another example, device 100 may be a device for capturing images, such as a camera device, where computing device 112 may include components for primarily displaying, storing, and/or remotely communicating images captured by the camera device.

In an example, the optional computing device 112 may include a bit unpacking component 114 and a display 116 for displaying advanced color images, such as high definition images including ultra high definition (UHD), wide color gamut (WCG), high dynamic range 10-bit (HDR10), and high dynamic range 12-bit (HDR12), etc. For example, the display 116 may include a liquid crystal display (LCD), plasma display, etc. Moreover, for example, computing device 112 may also include components for more modern compression (encoding) of advanced color images or video, such as an image re-encoding component 117 for re-encoding advanced color images or video to different formats, such as H.265 (also known as High Efficiency Video Codec, HEVC) encoding for video, High Efficiency Image File Format (HEIF), JPEG-extended range (XR) for image compression, etc. This may allow for achieving a more efficient storage and/or sharing of the images or video. For example, image re-encoding component 117 may store the re-encoded images in storage 118 (e.g., persistent or non-persistent memory on the computing device 112 or remotely located), and/or may communicate the re-encoded images to one or more other devices via communicating component 119, which may be similar to communicating component 110 as described above. In an example, device 100 and computing device 112 may be separate devices or the same device (e.g., located in the same housing), and thus may communicate via communicating component 110 over one or more internal bus interfaces, external interfaces, etc., as described further herein.

In an example, device 100 can include an image sensor 106 for generating image data in the form of an advanced color image. For example, image sensor 106 may include a camera sensor configured to capture the image and/or a stream of images (e.g., a video), which can be sampled and processed as a collection of pixels or other data representative of the advanced color image. In one example, image sensor 106 may be outside of the device 100 and can communicate with the device 100 via a wired or wireless interface. In addition, device 100 and/or image sensor 106 may be part of the computing device 112, in one example. Device 100 can also include a bit packing component 108 for packing at least one of the bits associated with values of parameters representing the pixels of the image to decrease a number of total byte values used for storing and/or communicating the image, storing the bits in an order to facilitate reading of all values associated with a given pixel or set of pixels before reading values associated with one or more next pixels, etc. Bit packing component 108 may store the packed bits in a memory (e.g., memory 104) and/or provide the packed bits to one or more other devices (e.g., computing device 112 via communicating component 110). Communicating component 110 can include substantially any wired or wireless interface for coupling the device 100 to computing device 112, such as universal serial bus (USB), Firewire, an internal bus interface (e.g., peripheral component interface (PCI)), local area network (LAN) connection, Bluetooth, near field communications (NFC), wireless LAN (WLAN) connection, etc. In addition, computing device 112 may include a bit unpacking component 114 for unpacking received bits for storing the bits in separate byte values for processing to obtain associated pixel values (e.g., for displaying the corresponding image on display 116, storing the corresponding image in a memory, sharing the corresponding image with another device, or otherwise operating on or with).

FIG. 2 is a flowchart of an example of a method 200 for packing bits of an advanced color image. For example, method 200 can at least partially be performed by a device 100, 112 and/or one or more components thereof (e.g., a bit packing component 108, processor 102, bit unpacking component 114, etc.) to facilitate bit packing and/or unpacking of pixel values for the advanced color images.

In method 200, at action 202, an image can be obtained. In an example, image sensor 106, e.g., in conjunction with processor 102, memory 104, etc., can obtain the image. For example, image sensor 106 may capture the image, or at least a portion thereof, as an advanced color image by sampling the image and representing the image as a set of values for a set of parameters for one or more pixels. For example, image sensor 106 can generate one or more luminance (Y) values, and at least two chroma values (Cb, Cr) to represent one or more pixels of the image. In one example, image sensor 106 can sample Y more than Cb, Cr, and in some formats may include 4 Y values, 1 Cb value, and 1 Cr value in representative pixels. For a 10-bit image, for example, each of the values hold 10 bits of color information (thus utilizing 60 total bits for 4 Y values, 1 Cb value, 1 Cr value). In addition, each value can be stored as a word, where a word can include a complete number of bytes (e.g., a 2 byte word can use two bytes, or 16 bits, for storing up to 16-bits of information, and thus storing the six 10-bit values in words can use 96 bits, where some bits in each word are not utilized for information—e.g., these bits can be zeroed out). In another example, processor 102 can obtain the advanced color image as an image stored in memory 104 (e.g., using six words per sample to represent four pixels). In any case, the advanced color image (e.g., represented using words to represent each value of multiple pixels) can be at least partially provided to bit packing component 108 for bit packing the bits to conserve data, such as to lessen the number of zeroed out bits, as described further herein.

In method 200, at action 204, a set of values stored in a first number of byte values can be determined, where each value in the set of values corresponds to a parameter in a set of parameters representing one or more pixels of the image. In an example, bit packing component 108, e.g., in conjunction with processor 102, memory 104, etc., can determine the set of values stored in the first number of byte values, where each value in the set of values corresponds to the parameter in the set of parameters representing the one or more pixels of the image. For example, bit packing component 108 can determine the Y values, Cb and Cr values associated with a given pixel or set of pixels in the image. For example, the Y values, Cb and Cr values can each be stored in a word that includes multiple complete byte values (e.g., a 2-byte word including two bytes, or 16 bits). Additionally, there can be more Y values than Cb and Cr values representing one or more pixels depending on the sampling of the advanced color image. In the case of a n-bit image, where n mod 8 !=0, bits of values representing parameters of one or more pixels can be packed to achieve even byte values, as described further herein.

In method 200, at action 206, the set of values can be packed into a set of byte values, where a second number of byte values in the set of byte values is less than the first number of byte values. In an example, bit packing component 108, e.g., in conjunction with processor 102, memory 104, etc., can pack the set of values into the set of byte values, where the second number of byte values in the set of byte values is less than the first number of byte values. The first number of byte values, for example, can correspond to a total number of byte values initially used to store the set of values obtained from the image, and the second number of byte values can correspond to a smaller total number of byte values used to store the set of bit-packed values, as described herein. In one example, packing the set of values at action 206 may optionally include, at action 208, modifying one or more values in the set of values to decrease a size of the set of values to a size of the second number of byte values. In an example, bit packing component 108 may remove one or more bits of a value (e.g., one or more least significant bits) to decrease the number of bits in the value.

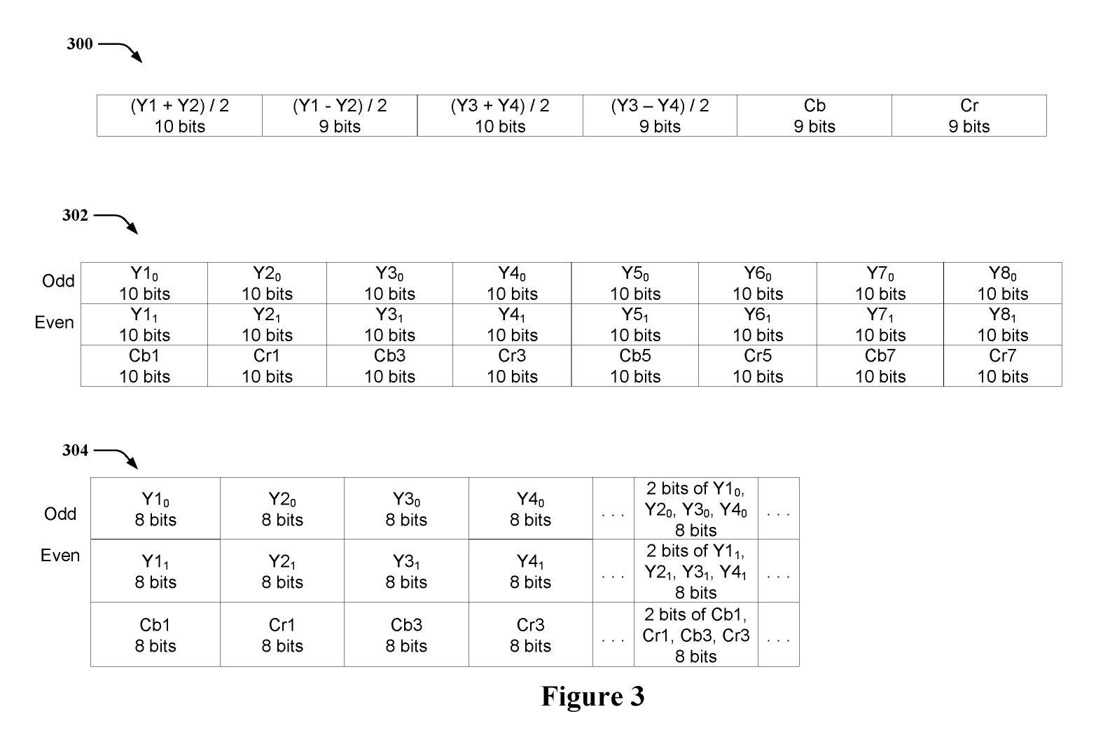

A specific non-limiting example is shown in FIG. 3, which illustrates an example byte line 300 including values representing parameters of one or more pixels. In this example, 4 Y values are shown along with a Cb and a Cr value (e.g., similar to a P010 or Y210 storage format), which may typically use 6 words of two bytes each for storage (12 bytes, or 96 bits). In byte line 300, the values can be bit packed and stored in 56 bits (or 7 bytes) to achieve the byte line format. For example, bit packing component 108 can store the values in byte line 300 by storing four values representative of the four luminance values in four portions of the byte line 300, a value representative of the Cb chroma value in a fifth portion of the byte line 300, and a value representative of the Cr chroma value in a sixth portion of the byte line 300. Specifically, in an example, bit packing component 108 can store a first value computed as a fraction (e.g., half) of the sum of two of the four 10-bit luminance values (Y1, Y2) in 10 bits, followed by a second value computed as a fraction (e.g., half) of the difference of the two of the four 10-bit luminance values (Y1, Y2) in 9 bits, followed by a third value computed as a fraction (e.g., half) of the sum of two other 10-bit luminance values (Y3, Y4) in 10 bits, followed by a fourth value computed as a fraction (e.g., half) of the difference of the two other 10-bit luminance values (Y3, Y4) in 9 bits. Additionally, bit packing component 108 can remove the least significant bit from each of the chroma values (Cb, Cr), and can store the chroma values each in 9 bits in the byte line 300, to achieve a total of 56 bits (or 7 bytes). For example, the least significant bit of the chroma values can be removed without substantial impact to perceptual quality of the image. In this format, the values of one or more pixels are packed contiguously to one another to achieve the smaller total number of bytes used in storing the corresponding pixels of the advanced color image.

In another specific non-limiting example shown in FIG. 3, bit packing component 108 can pack the bits into separate byte lines 302 to achieve the smaller total number of bytes. For example, bit packing component 108 can pack two sets of four pixels each (total of eight pixels) as follows where one set of four pixels is represented by values (Y1₀, Y2₀, Y1₁, Y2₁, Cb1, Cr1) and another set of four pixels is represented by values (Y3₀, Y4₀, Y3₁, Y4₁, Cb3, Cr3): 10-bit Y values (Y1₀, Y2₀, Y3₀, Y4₀) can be packed together using 10 bits for each value (40 bits total, or five bytes) in an odd byte line of five bytes, and 10-bit Y values (Y1₁, Y2₁, Y3₁, Y4₁) can be packed together using 10 bits for each value (40 bits total, or five bytes) in an even byte line and 10-bit Cb and Cr values (Cb1, Cr1, Cb3, Cr3) can be packed together using 10 bits for each value (40 bits total, or five bytes) in another byte line. In this format, the Y, Cb, Cr values for given pixels can be separated in memory location, but can be processed without significant buffering of Y values before also obtaining corresponding Cb, Cr values.

In another specific non-limiting example shown in FIG. 3, bit packing component 108 can pack the bits into separate byte lines 304, as similarly described with respect to byte lines 302, but separating the values into different portions to store the portions in complete bytes. For example, bit packing component 108 can pack 10-bit Y and Cb and Cr values for each of the pixels (e.g., (Y1₀, Y2₀, Y3₀, Y4₀,), (Y1₁, Y2₁, Y3₁, Y4₁), and (Cb1, Cr1, Cb3, Cr3)) using eight bits (e.g., the eight most significant bits) for each value, and another subsequent composite 8-bit value including the remaining two bits (e.g., the two least significant bits) of each of the four values in the set. In one example, the set of composite 8-bit values for the entire row can be dropped if not needed or desired, and/or can be used as a stride for the byte line. Thus, in one example including 16 pixels in a row, the first 16 bytes can include all of the 8-bit values including the eight most significant bits for Y, Cb, and Cr, and the next 4 bytes can include the remaining two (least significant) bits of each value. Accordingly, when using the stride, in an example, bit unpacking component 114 can utilize a width of 16 bytes and a stride of 20 bytes for a legacy application (e.g., the legacy application processes 16 bytes, but moves 20 bytes to get the next value), such that the four bytes of 2-bit values can be skipped for each collection of pixels. In another example, an application (e.g., an advanced or non-legacy application) can process all 20 bytes if desired.

In method 200, at action 210, the set of byte vales can be stored to represent the one or more pixels of the image. In an example, bit packing component 108, e.g., in conjunction with processor 102, memory 104, etc., can store the set of byte values (e.g., in memory 104) to represent the one or more pixels of the image. For example, bit packing component 108 can store the byte values (e.g., using one or more byte line formats, such as byte lines 300, 302, or 304 in FIG. 3) at least temporarily, to save the number of bits used in storing the values per one or more pixels of the advanced color image. For example, the boxes shown in FIG. 3 as representing the byte lines can correspond to adjacent memory locations in the memory. In another example, the boxes can represent adjacent storing of the values in an intermediate step before storing in the memory (e.g., before an encryption, scrambling, or other transformation process that may be performed on the values or associated byte lines before storing).

In method 200, optionally at action 212, the set of byte values can be communicated, along with a collection of various sets of byte values representing various pixels of the image. In an example, communicating component 110, e.g., in conjunction with processor 102, memory 104, etc., can communicate the set of byte values along with a collection of various sets of byte values representing various pixels of the image. For example, another device can include the computing device 112, to which device 100 can be coupled via one or more interfaces and/or within the same housing. Communicating component 110 can communicate the various sets of byte values, as packed, to the computing device 112 via substantially any wired or wireless interface (e.g., USB, Firewire, Bluetooth, PCI, etc., as described above) over a connection internal or external to a housing. In an example, the computing device 112 may accordingly obtain and unpack the bits, as described in further detail below, to display or otherwise process the corresponding pixels of the advanced color image.

In method 200, optionally at action 214, the set of byte values can be unpacked from the various sets of byte values to obtain the set of values for the set of parameters for the one or more pixels of the image. In an example, bit unpacking component 114, e.g., in conjunction with processor 102, memory 104, etc., can unpack the set of byte values from the various sets of byte values to obtain the set of values for the set of parameters for the one or more pixels of the image. For example, bit unpacking component 114 can determine which bits in the set of byte values correspond to associated parameters based on the format used to pack the bits, where the format and/or corresponding packing and/or unpacking algorithm may be known or otherwise determined by both bit packing component 108 and bit unpacking component 114. For example, bit unpacking component 114 can determine the bits based on knowing or otherwise receiving an indication that a certain byte line format (e.g., from FIG. 3) was used to pack the bits. In one example, where a format of byte lines 300, 302, or 304 is used, bit unpacking component 114 can utilize a bitmask to obtain corresponding bit values, and can determine the corresponding Y, Cb, Cr values for each of one or more pixels based on the corresponding bit values. For byte line 300, for example, bit unpacking component 114 may apply a formula to the first 10-bit portion and corresponding 9-bit portion to obtain Y1 and Y2. Additionally, as described, bit unpacking component 114 may utilize a different width and stride when processing the bit packed values to drop a portion (e.g., the last four bits) of a given value (e.g., for legacy applications).

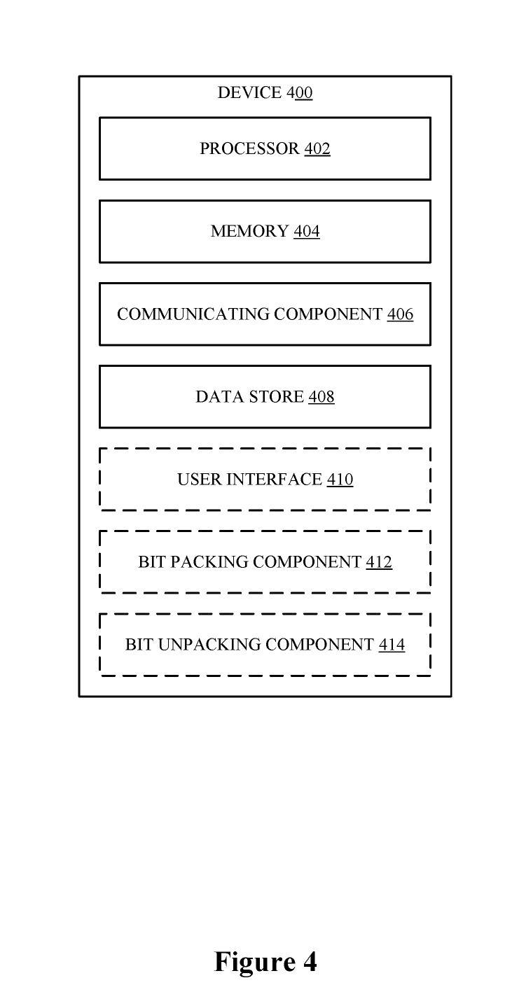

FIG. 4 illustrates an example of device 400 including additional optional component details as those shown in FIG. 1. In one aspect, device 400 may include processor 402, which may be similar to processor 102 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 may further include memory 404, which may be similar to memory 104 such as for storing local versions of operating systems (or components thereof) and/or applications being executed by processor 402, such as bit packing component 412, bit unpacking component 414, etc., related instructions, parameters, etc. Memory 404 can include a type of memory usable by a computer, such as random access memory (RAM), read only memory (ROM), tapes, magnetic discs, optical discs, volatile memory, non-volatile memory, and any combination thereof.

Further, device 400 may include a communicating component 406 that provides for establishing and maintaining communications with one or more other devices, parties, entities, etc. utilizing hardware, software, and services as described herein. Communicating component 406 may be similar to communicating component 110, and may carry communications between components on device 400, as well as between device 400 and external devices, such as devices located across a communications network and/or devices serially or locally connected to device 400. For example, communicating component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc., not currently being executed by processor 402. In addition, data store 408 may be a data repository for bit packing component 412, bit unpacking component 414 and/or one or more other components of the device 400.

Device 400 may optionally include a user interface component 410 operable to receive inputs from a user of device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

Device 400 may optionally additionally include an bit packing component 412, which may be similar to bit packing component 108, for packing bits corresponding to parameter values of a pixel for storing in memory 404, communicating via communicating component 406, etc., and/or a bit unpacking component 414, which may be similar to bit unpacking component 114 for unpacking bits of byte values representing parameters values of the pixels, as described herein.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for storing an advanced color image, comprising:
determining a set of values stored in a first number of byte values, wherein each value in the set of values corresponds to a parameter of a set of parameters representing one or more pixels of an advanced color image;
packing the set of values into a set of byte values, wherein a second number of byte values in the set of byte values is less than the first number of byte values; and
storing the set of byte values to represent the one or more pixels of the advanced color image.

2. The method of claim 1, wherein packing the set of values comprises modifying one or more values in the set of values to decrease a size of the set of values to a size of the second number of byte values.

3. The method of claim 1, wherein the set of parameters include, for the one or more pixels, a set of 10-bit luminance values, a first 10-bit chroma value, and a second 10-bit chroma value, and wherein packing the set of values comprises:
using a first portion of the set of byte values to represent a first value determined based on a first luminance value and a second luminance value;
using a second portion of the set of byte values to represent a second value determined based on the first luminance value and the second luminance value;
using a third portion of the set of byte values to represent a third value determined based on a third luminance value and a fourth luminance value;
using a fourth portion of the set of byte values to represent a fourth value determined based on the third luminance value and the fourth luminance value;
using a fifth portion of the set of byte values to represent at least a portion of the first 10-bit chroma value; and
using a sixth portion of the set of byte values to represent at least a portion of the second 10-bit chroma value.

4. The method of claim 3, further comprising:
determining the first value as half of the sum of the first luminance value and the second luminance value, wherein using the first portion of the set of byte values comprises using 10 bits of the set of byte values to represent the first value;
determining the second value as half of the difference of the first luminance value and the second luminance value, wherein using the second portion of the set of byte values comprises using 9 bits of the set of byte values to represent the second value;
determining the third value as half of the sum of the third luminance value and the fourth luminance value, wherein using the third portion of the set of byte values comprises using 10 bits of the set of byte values to represent the third value; and
determining the fourth value as half of the difference of the third luminance value and the fourth luminance value, wherein using the fourth portion of the set of byte values comprises using 9 bits of the set of byte values to represent the fourth value,
wherein using the fifth portion of the set of byte values comprises using 9 bits of the set of byte values to represent at least the portion of the first 10-bit chroma value, and
wherein using the sixth portion of the set of byte values comprises using 9 bits of the set of byte values to represent at least the portion of the second 10-bit chroma value.

5. The method of claim 1, wherein the set of parameters include, for the one or more pixels, a first set of four 10-bit luminance values, a second set of four 10-bit luminance values, two 10-bit chroma values, and two second 10-bit chroma values, and wherein packing the set of values comprises:
using a first portion of the set of byte values in an odd byte line to represent two of the first set of four 10-bit luminance values and two of the second set of four 10-bit luminance values;
using a second portion of the set of byte values in an even byte line to represent another two of the first set of four 10-bit luminance values and another two of the second set of four 10-bit luminance values;
using a third portion of the set of byte values in a third byte line to represent the two 10-bit chroma values and the two second 10-bit chroma values.

6. The method of claim 5, wherein using the first portion of the set of byte values comprises:
sequentially representing a first initial 8 bits of one of the two of the first set of four 10-bit luminance values, a second initial 8 bits of the other one of the two of the first set of four 10-bit luminance values, a third initial 8 bits of one of the two of the second set of four 10-bit luminance values, a fourth initial 8 bits of the other one of the two of the second set of four 10-bit luminance values in contiguous memory locations of the set of byte values; and
representing, in a fifth 8-bit set, a first remaining two bits of the one of the two of the first set of four 10-bit luminance values, a second remaining 2 bits of the other one of the two of the first set of four 10-bit luminance values, a third remaining 2 bits of the one of the two of the second set of four 10-bit luminance values, and a fourth remaining 2 bits of the other one of the two of the second set of four 10-bit luminance values.

7. The method of claim 6, wherein using the second portion of the set of byte values comprises:
sequentially representing a sixth initial 8 bits of one of the another two of the first set of four 10-bit luminance values, a seventh initial 8 bits of the other one of the another two of the first set of four 10-bit luminance values, an eighth initial 8 bits of one of the another two of the second set of four 10-bit luminance values, a ninth initial 8 bits of the other one of the another two of the second set of four 10-bit luminance values in contiguous memory locations of the set of byte values; and
representing, in a tenth 8-bit set, a first remaining two bits of the one of the another two of the first set of four 10-bit luminance values, a second remaining 2 bits of the other one of the another two of the first set of four 10-bit luminance values, a third remaining 2 bits of the one of the another two of the second set of four 10-bit luminance values, and a fourth remaining 2 bits of the other one of the another two of the second set of four 10-bit luminance values.

8. The method of claim 7, wherein using the third portion of the set of byte values comprises:
sequentially representing an eleventh initial 8 bits of one of the two 10-bit chroma values, a twelfth initial 8 bits of the other one of the two 10-bit chroma values, a thirteenth initial 8 bits of one of the two second 10-bit chroma values, and a fourteenth initial 8 bits of the other one of the two second 10-bit chroma values in contiguous memory locations of the set of byte values; and
representing, in a fifteenth 8-bit set, a first remaining two bits of the one of the two 10-bit chroma values, a second remaining 2 bits of the other one of the two 10-bit chroma values, a third remaining 2 bits of the one of the two second 10-bit chroma values, and a fourth remaining 2 bits of the other one of the two second 10-bit chroma values.

9. The method of claim 8, further comprising representing at least one of the fifth 8-bit set, the tenth 8-bit set, or the fifteenth 8-bit set as a stride for the byte line, wherein the stride is stored after the odd byte line, the even byte line, and the third byte line.

10. A device for storing an advanced color image, comprising:
an image sensor configured to capture a raw image;
a memory for storing one or more parameters or instructions for storing the raw image as an advanced color image in a set of byte values; and
at least one processor coupled to the memory, wherein the at least one processor is configured to:
determine a set of values stored in a first number of byte values, wherein each value in the set of values corresponds to a parameter of a set of parameters representing one or more pixels of the advanced color image;
pack the set of values into the set of byte values, wherein a second number of byte values in the set of byte values is less than the first number of byte values; and
store the set of byte values to represent the one or more pixels of the advanced color image.

11. The apparatus of claim 10, wherein at least one processor is configured to pack the set of values at least in part by modifying one or more values in the set of values to decrease a size of the set of values to a size of the second number of byte values.

12. The apparatus of claim 10, wherein the set of parameters include, for the one or more pixels, a set of 10-bit luminance values, a first 10-bit chroma value, and a second 10-bit chroma value, and wherein the at least one processor is configured to pack the set of values at least in part by:
using a first portion of the set of byte values to represent a first value determined based on a first luminance value and a second luminance value;
using a second portion of the set of byte values to represent a second value determined based on the first luminance value and the second luminance value;
using a third portion of the set of byte values to represent a third value determined based on a third luminance value and a fourth luminance value;
using a fourth portion of the set of byte values to represent a fourth value determined based on the third luminance value and the fourth luminance value;
using a fifth portion of the set of byte values to represent at least a portion of the first 10-bit chroma value; and
using a sixth portion of the set of byte values to represent at least a portion of the second 10-bit chroma value.

13. The apparatus of claim 12, wherein the at least one processor is further configured to:
determine the first value as half of the sum of the first luminance value and the second luminance value, wherein using the first portion of the set of byte values comprises using 10 bits of the set of byte values to represent the first value;
determine the second value as half of the difference of the first luminance value and the second luminance value, wherein using the second portion of the set of byte values comprises using 9 bits of the set of byte values to represent the second value;
determine the third value as half of the sum of the third luminance value and the fourth luminance value, wherein using the third portion of the set of byte values comprises using 10 bits of the set of byte values to represent the third value; and
determine the fourth value as half of the difference of the third luminance value and the fourth luminance value, wherein using the fourth portion of the set of byte values comprises using 9 bits of the set of byte values to represent the fourth value,
wherein using the fifth portion of the set of byte values comprises using 9 bits of the set of byte values to represent at least the portion of the first 10-bit chroma value, and
wherein using the sixth portion of the set of byte values comprises using 9 bits of the set of byte values to represent at least the portion of the second 10-bit chroma value.

14. The apparatus of claim 10, wherein the set of parameters include, for the one or more pixels, a first set of four 10-bit luminance values, a second set of four 10-bit luminance values, two 10-bit chroma values, and two second 10-bit chroma values, and wherein the at least one processor is configured to pack the set of values at least in part by:
using a first portion of the set of byte values in an odd byte line to represent two of the first set of four 10-bit luminance values and two of the second set of four 10-bit luminance values;
using a second portion of the set of byte values in an even byte line to represent another two of the first set of four 10-bit luminance values and another two of the second set of four 10-bit luminance values;
using a third portion of the set of byte values in a third byte line to represent the two 10-bit chroma values and the two second 10-bit chroma values.

15. The apparatus of claim 14, wherein using the first portion of the set of byte values comprises:
sequentially representing a first initial 8 bits of one of the two of the first set of four 10-bit luminance values, a second initial 8 bits of the other one of the two of the first set of four 10-bit luminance values, a third initial 8 bits of one of the two of the second set of four 10-bit luminance values, a fourth initial 8 bits of the other one of the two of the second set of four 10-bit luminance values in contiguous memory locations of the set of byte values; and
representing, in a fifth 8-bit set, a first remaining two bits of the one of the two of the first set of four 10-bit luminance values, a second remaining 2 bits of the other one of the two of the first set of four 10-bit luminance values, a third remaining 2 bits of the one of the two of the second set of four 10-bit luminance values, and a fourth remaining 2 bits of the other one of the two of the second set of four 10-bit luminance values.

16. The apparatus of claim 15, wherein using the second portion of the set of byte values comprises:
sequentially representing a sixth initial 8 bits of one of the another two of the first set of four 10-bit luminance values, a seventh initial 8 bits of the other one of the another two of the first set of four 10-bit luminance values, an eighth initial 8 bits of one of the another two of the second set of four 10-bit luminance values, a ninth initial 8 bits of the other one of the another two of the second set of four 10-bit luminance values in contiguous memory locations of the set of byte values; and
representing, in a tenth 8-bit set, a first remaining two bits of the one of the another two of the first set of four 10-bit luminance values, a second remaining 2 bits of the other one of the another two of the first set of four 10-bit luminance values, a third remaining 2 bits of the one of the another two of the second set of four 10-bit luminance values, and a fourth remaining 2 bits of the other one of the another two of the second set of four 10-bit luminance values.

17. The apparatus of claim 16, wherein using the third portion of the set of byte values comprises:
sequentially representing an eleventh initial 8 bits of one of the two 10-bit chroma values, a twelfth initial 8 bits of the other one of the two 10-bit chroma values, a thirteenth initial 8 bits of one of the two second 10-bit chroma values, and a fourteenth initial 8 bits of the other one of the two second 10-bit chroma values in contiguous memory locations of the set of byte values; and
representing, in a fifteenth 8-bit set, a first remaining two bits of the one of the two 10-bit chroma values, a second remaining 2 bits of the other one of the two 10-bit chroma values, a third remaining 2 bits of the one of the two second 10-bit chroma values, and a fourth remaining 2 bits of the other one of the two second 10-bit chroma values.

18. The apparatus of claim 17, wherein the at least one processor is further configured to represent at least one of the fifth 8-bit set, the tenth 8-bit set, or the fifteenth 8-bit set as a stride for the byte line, wherein the stride is stored after the odd byte line, the even byte line, and the third byte line.

19. A computer-readable medium, comprising code executable by one or more processors for storing an advanced color image, the code comprising code for:
determining a set of values stored in a first number of byte values, wherein each value in the set of values corresponds to a parameter of a set of parameters representing one or more pixels of an advanced color image;
packing the set of values into a set of byte values, wherein a second number of byte values in the set of byte values is less than the first number of byte values; and
storing the set of byte values to represent the one or more pixels of the advanced color image.

20. The computer-readable medium of claim 19, wherein the code for packing the set of values comprises code for modifying one or more values in the set of values to decrease a size of the set of values to a size of the second number of byte values.
